(19) United States
(12) Patent Application Publication
(10) Pub. No.: US 2025/0003756 A1
(43) Pub. Date: Jan. 2, 2025

(54) SYSTEM AND METHOD FOR PROVIDING INFOTAINMENT VIRTUALIZATION SERVICE

(71) Applicant: DRIMAES, INC., Daegu (KR)

(72) Inventors: WooHyun Seol, Seoul (KR); Woojin HAN, Seoul (KR); Anna YANG, Seongnam-si (KR); Inho LEE, Seoul (KR); Jisu KONG, Seoul (KR)

(21) Appl. No.: 18/361,727

(22) Filed: Jul. 28, 2023

(30) Foreign Application Priority Data
Jun. 27, 2023 (KR) 10-2023-0082583

(51) Int. Cl. G01C 21/34

(52) U.S. Cl. CPC G01C 21/3438; G01C 21/3484

(57) ABSTRACT

A personalized infotainment virtualization method in a car sharing environment is provided. The method includes receiving personalized data from a cloud when receiving a request from a user, storing the personalized data in a physical repository within an automotive infotainment system, reading the personalized data by connecting a virtual repository that is generated through a virtual machine and the physical repository when the virtual machine is executed through a predetermined virtualization library, and executing a service application that is to operate in the virtual machine based on the personalized data.

### CROSS-REFERENCE TO RELATED APPLICATION

This application claims priority under 35 U.S.C § 119 to Korean Patent Application No. 10-2023-0082583 filed in the Korean Intellectual Property Office on Jun. 27, 2023, the entire contents of which are hereby incorporated by reference.

### BACKGROUND

### 1. Technical Field

The present disclosure relates to a system and method for providing an infotainment virtualization service and to a system and method for providing a personalized infotainment virtualization service in a car sharing environment.

### 2. Related Art

An infotainment system in a car sharing environment (or a shared car environment) has a problem in that many people have to use the same infotainment system and limited service whenever they rent cars because the automotive infotainment system has been standardized like common cars. This does not satisfy various requests or habits of users and may cause limited car user experiences.

Furthermore, in the existing infotainment system, navigation paths and device connection information of users may remain even after car rental. This may cause a problem with the personal information protection of users and the leakage of personal information.

### SUMMARY

Various embodiments are directed to providing personalized infotainment for an unspecified number of car rentees and providing a system and method for providing a personalized infotainment virtualization service in a car sharing environment, wherein personal information can be protected by managing for each car rentee through the construction of the data for personalization and a cloud environment and discarding personal data within a car upon car return.

Furthermore, various embodiments are directed to providing an automotive infotainment system supporting multiple connections, which can flexibly operate by facilitating a connection change of multiple user devices that have been registered with the automotive infotainment system, and a method of the automotive infotainment system supporting multiple connections.

However, objects of the present disclosure to be achieved are not limited to the aforementioned objects, and other objects may be present.

A method that is performed by a personalized infotainment virtualization system in a car sharing environment according to a first aspect of the present disclosure includes receiving personalized data from a cloud when receiving a request from a user, storing the personalized data in a physical repository within an automotive infotainment system, reading the personalized data by connecting a virtual repository that is generated through a virtual machine and the physical repository when the virtual machine is executed through a predetermined virtualization library, and executing a service application that is to operate in the virtual machine based on the personalized data.

In some embodiments of the present disclosure, the receiving of the personalized data from the cloud when receiving the request from the user may include receiving any one of a request for car rental, a request for a car return, and a request to execute a specific service from any one of an unspecified number of users.

In some embodiments of the present disclosure, the receiving of the personalized data from the cloud when receiving the request from the user may include receiving user data including a car rental user ID, a rental car ID, and rental time information and service data including user driving information, device connection information, service use information, and other personal information.

In some embodiments of the present disclosure, the method may further include receiving, from the cloud, the personalized data updated based on the user ID after the car is rented, and updating the personalized data stored in the physical repository based on the updated personalized data.

In some embodiments of the present disclosure, the executing of the service application that is to operate in the virtual machine based on the personalized data may include detecting service use information included in the service data, detecting user data corresponding to the service use information, and executing a corresponding service application based on the service use information and the user data.

In some embodiments of the present disclosure, the method may further include receiving a request for a car return from the user, terminating the virtual machine that is being executed, transmitting the personalized data stored in the physical repository to the cloud, and discarding the personalized data stored in the physical repository.

In some embodiments of the present disclosure, the transmitting of the personalized data stored in the physical repository to the cloud may include transmitting, to the cloud, the personalized data of the physical repository in which personalized data that has been newly generated while the car is rented is also stored.

Furthermore, a personalized infotainment virtualization system in a car sharing environment according to a second aspect of the present disclosure includes a physical repository configured to store personalized data received from a cloud, a kernel configured to manage the personalized data stored in the physical repository, a virtual machine configured to generate a virtual repository when the virtual machine is executed through a predetermined virtualization library, read the personalized data by connecting the virtual repository to the physical repository, store the read personalized data in the virtual repository, and execute a service application that is to operate in a virtual environment based on the personalized data.

Furthermore, a computer program according to another aspect of the present disclosure executes the method of providing a personalized infotainment virtualization service in a car sharing environment in combination with a computer, that is, hardware, and is stored in a computer-readable recording medium.

Other details of the present disclosure are included in the detailed description and the drawings.

According to the present disclosure, a personalized infotainment environment can be provided to an unspecified number of users who use a shared car. Furthermore, effects in that data security and the protection of personal information are possible and various user-customized environments can be supported by discarding personalized data that have been stored in a car upon downloading of personalized data through a cloud and upon car return may be expected.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram schematically illustrating a construction of the entire system according to an embodiment of the present disclosure.

FIG. 2 is a block diagram of a system for providing an infotainment virtualization service according to an embodiment of the present disclosure.

FIG. 3 is a diagram for describing personalized data according to an embodiment of the present disclosure.

FIG. 4 is a construction diagram of a system for providing an infotainment virtualization service according to an embodiment of the present disclosure.

FIG. 5 is a flowchart for describing a method that is performed by the infotainment virtualization system according to an embodiment of the present disclosure.

FIG. 6 is a flowchart for describing a method that is performed by a cloud according to an embodiment of the present disclosure.

FIG. 7 is a block diagram of an automotive infotainment system according to an embodiment of the present disclosure.

FIG. 8 is a diagram for describing contents in which a plurality of sub-containers is controlled in an embodiment of the present disclosure.

FIG. 9 is a flowchart of a method of supporting a device connection between multiple users according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

An embodiment of the present disclosure relates to a system and method for providing a personalized infotainment virtualization service in a car sharing environment.

The present disclosure can provide services, for example, an optimized driving path and a recommendation on a good restaurant by using personalized data in response to user preference or a request from a user when the user rents a car.

Furthermore, personal information can be protected by discarding and managing personalized data, such as navigation paths or device connection information, so that the personalized data are prevented from remaining in a car upon car return.

Unlike the existing standardized infotainment system, a system according to an embodiment of the present disclosure operates based on a virtualized environment, and can meet a personalized request from a user and provide better car usage experiences by solving a problem with a limited device connection and service upon car rental.

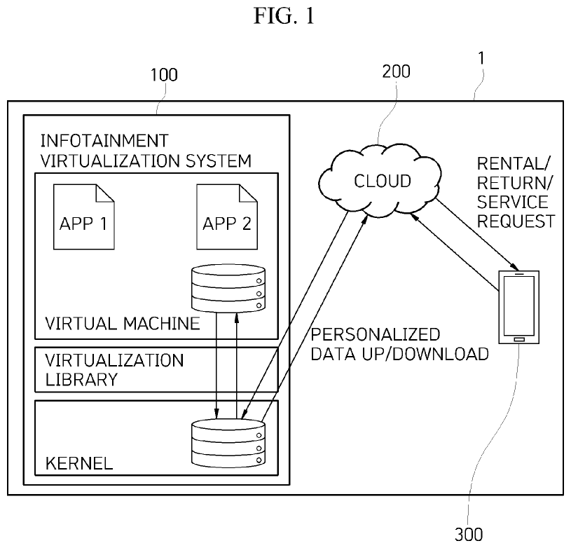

Hereinafter, a system for providing an infotainment virtualization service according to an embodiment of the present disclosure is described with reference to FIGS. 1 to 4.

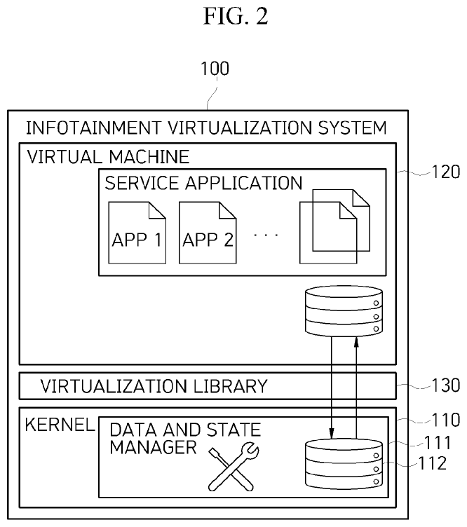

FIG. 1 is a diagram schematically illustrating a construction of the entire system 1 according to an embodiment of the present disclosure. FIG. 2 is a block diagram of a system 100 for providing an infotainment virtualization service according to an embodiment of the present disclosure.

The entire system 1 according to an embodiment of the present disclosure includes the system 100 for providing an infotainment virtualization service (also called an infotainment virtualization system 100), a cloud 200, and a user terminal 300.

The components of the entire system 1 illustrated in FIG. 1 may be connected over a network. The network means a connection structure in which information can be exchanged between nodes, such as terminals and servers. Examples of such a network include a 3rd generation partnership project (3GPP) network, long term evolution (LTE) network, a world interoperability for microwave access (WIMAX) network, Internet, a local area network (LAN), a wireless local area network (wireless LAN), a wide area network (WAN), a personal area network (PAN), a Bluetooth network, a satellite broadcasting network, an analog broadcasting network, a digital multimedia broadcasting (DMB) network, and Wi-Fi, but the present disclosure is not limited thereto.

The cloud 200 relays data between the user terminal 300 and the infotainment virtualization system 100. When receiving information on a request for the rental or return of a shared car and other services from the user terminal 300, the cloud 200 transmits the information on the request to the infotainment virtualization system 100. Furthermore, the cloud 200 provides the infotainment virtualization system 100 with personalized data that is received from the user terminal 300, or collects and stores new personalized data that are generated by the infotainment virtualization system 100 or the user terminal 300 while a shared car drives.

The infotainment virtualization system 100 operates in an infotainment system, but operates in a virtualized environment unlike a conventional infotainment system. The infotainment virtualization system 100 may include a physical repository 112, a kernel 110, and a virtual machine 120.

The physical repository 112 stores personalized data that are received from the cloud 200. The physical repository 112 may be commonly a hard drive or flash memory.

The kernel 110 is installed in an actual physical infotainment system, and is a core component of an operating system that manages personalized data that have been stored in the physical repository 112. The kernel 110 may provide functions, such as memory management, process scheduling, and a device driver, and may efficiently manage resources within the infotainment virtualization system 100. The kernel 110 may include a data and state manager 111. The data and state manager 111 manages the execution and termination of the virtual machine 120, and may perform tasks, such as the addition, deletion, and change of personalized data stored in the physical repository 112.

The virtual machine 120 provides an independent computing environment based on the virtualization technology, and stably operate by be isolated from a host system through the virtualization technology. The virtual machine 120 is generated when being executed through a predetermined virtualization library 130. In this case, the predetermined virtualization library 130 may be QEMU or KVM.

The virtual machine 120 generates a virtual repository (not illustrated) and connects the virtual repository to the physical repository 112. Furthermore, the virtual machine 120 reads personalized data stored in the physical repository 112 and stores the read personalized data in the virtual repository. Thereafter, the virtual machine 120 may provide a customized infotainment environment to a user by executing a service application that will operate in a virtual environment based on the personalized data stored in the virtual repository.

In an embodiment of the present disclosure, the virtual machine 120 may be generated for each operating system of the user terminal. For example, the virtual machine 120 may be generated and may operate for each operating system of the user terminal, such as Android or iOS.

As another embodiment, the virtual machine 120 may be generated based on the number of user terminals 200. That is, in an embodiment of the present disclosure, the independent virtual machine 120 may provide a personalized environment by being generated for each user, and can prevent an interaction between the virtual machines 120 from being influenced mutually.

However, in the latter case, if the number of users for a specific shared car is large, the number of virtual machines 120 is rapidly increased. This may cause many costs in performance and maintenance of the infotainment virtualization system.

Accordingly, in an embodiment of the present disclosure, preferably, when the number of users is equal to or less than a preset number, the infotainment virtualization system may operate as in the latter case. In this case, when the number of users is greater than the preset number, the infotainment virtualization system may operate as in the former case.

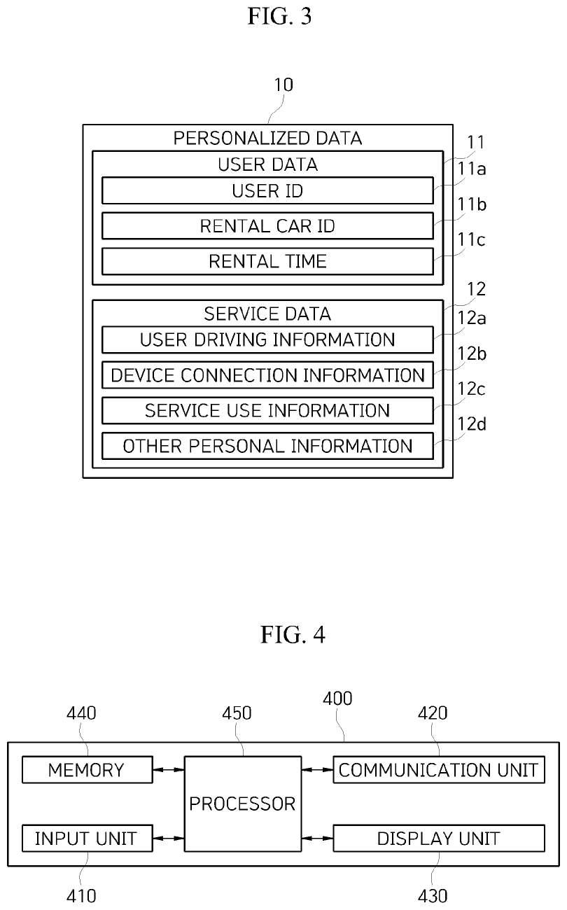

FIG. 3 is a diagram for describing personalized data 10 according to an embodiment of the present disclosure.

In an embodiment of the present disclosure, the personalized data 10 may include user data 11 and service data 12.

The user data 11 includes car rental user ID 11a, a rental car ID 11b, and rental time information 11c.

The car rental user ID 11a is a unique identifier for identifying a car rental user. Each user may have a unique user ID, and may manage the personalized data 10 of the user based on the unique user ID.

The rental car ID 11b is a unique identifier for identifying a rented car. Each rental car may have a unique car ID, and may track and manage information related to the car.

The rental time information 11c indicates a time for which a car rented, and may be used to check a time or period for which a user has used a car and to calculate service use and fees.

The service data 12 may include user driving information 12a, device connection information 12b, service use information 12c, and other personal information 12d.

The user driving information 12a may include information related to the car driving of a user. For example, the user driving information 12a may include information, such as a driving distance, a driving time, a moving path, and a driving pattern. More specifically, the user driving information 12a may include information, such as a path that is frequently used by a user, driving habits, and other driving information.

The device connection information 12b includes information on a connection between the user terminal and the automotive infotainment system, such as Bluetooth. For example, the device connection information 12b is provided to the automotive infotainment system when a user rents a car in the state in which the device connection information 12b has been previously collected and stored through the cloud. Accordingly, device utilization convenience of a user, such as immediately providing services associated with the user terminal, can be improved.

The service use information 12c means a service use history of a user, such as information on the use of a service added in response to a request from a user. The preference of a user may also be checked and a customized service can be provided to a user, based on the service use information 12c.

In addition, other personal information 12d may include information that is required when a service through a shared car or the infotainment virtualization system 100 is used, such as the name, contact information, e-mail, and payment information of a user.

FIG. 4 is a construction diagram of the system for providing an infotainment virtualization service according to an embodiment of the present disclosure.

Referring to FIG. 4, the system 100 for providing an infotainment virtualization service includes an input unit 410, a communication unit 420, a display unit 430, memory 440, and a processor 450.

The input unit 410 generates input data in response to a user input to the infotainment virtualization system. The input unit 410 includes at least one piece of input means. The input unit 410 may include a keyboard, a key pad, a dome switch, a touch panel, a touch key, a mouse, and a menu button.

The communication unit 420 supports the transmission and reception of internal data or external data of the infotainment virtualization system 100. The communication unit 420 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be constructed as a module for implementing a function, such as a wireless LAN (WLAN), Bluetooth, an HDR WPAN, UWB, ZigBee, impulse radio, a 60 GHz WPAN, binary-CDMA, a wireless USB technology, a wireless HDMI technology, 5th generation (5G) communication, long term evolution-advanced (LTE-A), long term evolution (LTE), or wireless fidelity (Wi-Fi).

The display unit 430 outputs data according to an operation of the infotainment virtualization system 100, for example, media data or displays other use service screens. The display unit 430 includes a liquid crystal display (LCD), a light emitting diode (LED) display, an organic light-emitting diode (OLED) display, a micro electro mechanical systems (MEMS) display, and an electronic paper display. The display unit 430 may be implemented as a touch screen by being combined with the input unit 410.

The memory 440 stores operating programs of the infotainment virtualization system 100. In this case, the memory 440 commonly refers to a nonvolatile storage device that retains information stored therein although power is not supplied to the nonvolatile storage device and a volatile storage device. For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The processor 450 may control at least another component (e.g., a hardware or software component) of the infotainment virtualization system 100 by executing software, such as a program stored in the memory, and may perform various data processing or operations.

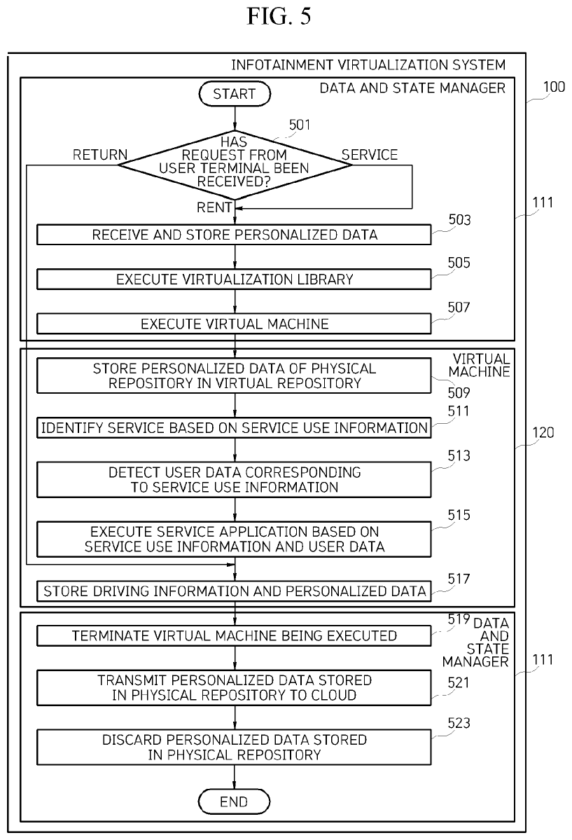

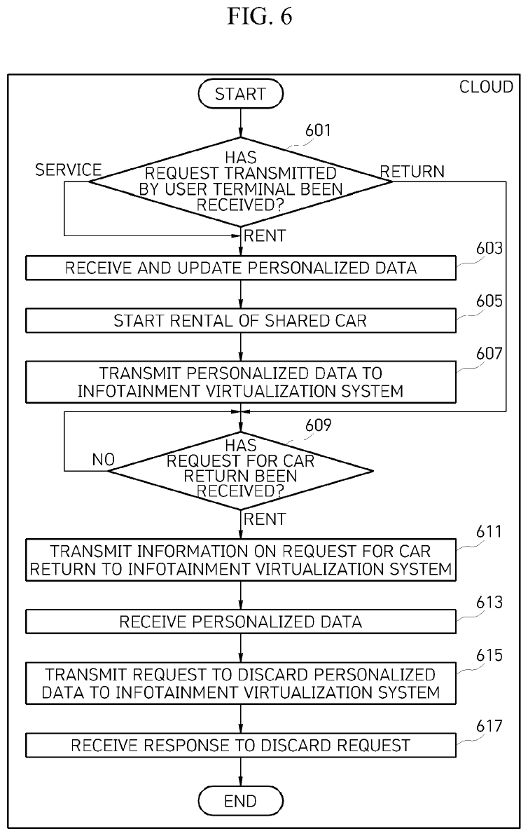

Hereinafter, a method that is performed by the infotainment virtualization system 100 and the cloud 200 according to an embodiment of the present disclosure is described with reference to FIGS. 5 and 6.

FIG. 5 is a flowchart for describing a method that is performed by the infotainment virtualization system 100 according to an embodiment of the present disclosure.

First, the data and state manager 111 within the kernel 110 receives, from the cloud 200, a request transmitted by the user terminal 300 (501). In this case, the request from a user may be the rental or return of a shared car or a service that is provided through the infotainment virtualization system. In an embodiment of the present disclosure, as a shared car is targeted, a user corresponds to any one user of an unspecified number of users.

When receiving a request for car rental from a user, the data and state manager 111 receives, from the cloud 200, the personalized data 10 based on a user ID, and stores the received personalized data 10 in the physical repository 112 within the infotainment virtualization system 100 (503). If the cloud 200 has updated personalized data 10 that have been newly collected from the user terminal 300 after a car is rented, the data and state manager 111 may receive the updated personalized data 10 from the cloud 200 and update the personalized data 10 that have been stored in the physical repository 112.

Next, the data and state manager 111 executes the virtual machine 120 by executing the virtualization library 130 (505 and 507).

When the virtual machine 120 is executed, the virtual machine 120 generates the virtual repository, connects the generated virtual repository and the physical repository 112, and then reads the personalized data 10 stored in the physical repository 112 and stores the read personalized data 10 in the virtual repository (509).

Next, the virtual machine 120 identifies a service based on service use information that has been included in the service data of the personalized data 10 stored in the virtual repository (511), detects user data corresponding to the service use information (513), and executes a service application that will operate in the virtual machine 120 based on the service use information and the user data (515). The service application operates based on the personalized data 10, and may provide a customized infotainment environment, for example, an optimized driving path, a recommendation on a good restaurant, or other requested services.

Next, driving information that is generated during car driving and the personalized data 10 that is generated in the infotainment virtualization system 100 are stored (517).

Thereafter, when receiving a request for the return of the rental car from the user, the data and state manager 111 terminates the virtual machine 120 that is being executed (519), and transmits, to the cloud 200, the personalized data 10 that have been stored in the physical repository 112 (521). The data and state manager 111 discards the personalized data 10 stored in the physical repository 112 (523) simultaneously with the completion of the transmission of the personalized data 10.

FIG. 6 is a flowchart for describing a method that is performed by the cloud 200 according to an embodiment of the present disclosure.

First, the cloud 200 receives a request transmitted by the user terminal 300 (601). In this case, the request from a user may be the rental or return of a shared car or a service that is provided through the infotainment virtualization system.

Next, after updating the personalized data 10 by receiving the personalized data 10 from the user terminal 300 (603), the cloud 200 transmits the personalized data 10 to the infotainment virtualization system 100 (607) when the rental of a shared car is started (605).

Thereafter, when receiving a request for a car return from the user terminal 300 (609), the cloud 200 transmits information on the request for the car return to the infotainment virtualization system 100 (611), and receives, from the infotainment virtualization system 100 or the user terminal 300, the personalized data 10 that have been newly generated during car driving (613).

Next, the cloud 200 transmits a request to discard the personalized data 10 to the infotainment virtualization system 100 (615), and then receives a response for the corresponding request from the infotainment virtualization system 100 (617).

As described above, an embodiment of the present disclosure can efficiently manage resources within the infotainment virtualization system 100 by terminating the virtual machine 120, transmitting the personalized data 10 to the cloud 200, and then discarding the personalized data 10 stored in the physical repository 112, and can optimize the space and processing ability by terminating the virtual machine 120 that is no longer used and deleting data stored in the physical repository 112.

Furthermore, the protection of personal information which may be easily drained from a shared car that is used by an unspecified number of people and abused can be enhanced. The personalized data 10 can be safely managed through a predetermined security mechanism in the cloud 200.

Furthermore, an embodiment of the present disclosure can provide a user with a more flexible shared car rental service. That is, a customized infotainment environment can be provided to a user without being limited to a car because the personalized data 10 are downloaded onto the infotainment virtualization system 100 of a shared car whenever the shared car is rented. In this case, there are advantages in that a service can be expanded and flexible measures can be taken because the personalized data 10 are managed based on the cloud 200 although the number of users is increased or service requirements are changed.

In addition, an embodiment of the present disclosure has an advantage in that it can provide a better infotainment environment because the driving and car usage experiences of various users are collected and the personalized data 10 in the user terminal 300 are collected, through a structure in which the personalized data 10 are collected and managed based on the cloud 200 and provided to the infotainment virtualization system 100 of each shared car.

In the aforementioned description, steps 501 to 617 may be further divided into additional steps or may be combined into smaller steps depending on an implementation example of the present disclosure. Furthermore, some steps may be omitted, if necessary, and the sequence of steps may be changed. Furthermore, although contents are omitted, the contents described with reference to FIGS. 1 to 4 and the contents described with reference to FIGS. 5 and 6 are mutually applied.

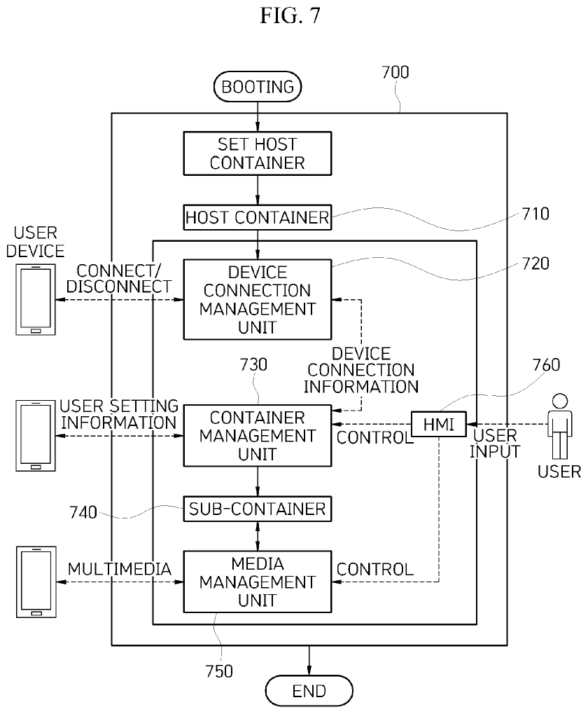

Hereinafter, an automotive infotainment system 700 supporting multiple connections according to another embodiment (second embodiment) of the present disclosure and a method of supporting a device connection between multiple users are described with reference to FIGS. 7 to 9. The technical characteristics of the first embodiment and the second embodiment described with reference to FIGS. 1 to 6 may be mutually shared or partially applied depending on an embodiment of each step. That is, the method of supporting multiple connections according to the second embodiment may be performed in the state in which the automotive infotainment system 100 operates in a virtual environment and provides a service based on the personalized data 10 according to the first embodiment, or vice versa, or the first embodiment and the second embodiment may be performed simultaneously.

An embodiment of the present disclosure relates to the automotive infotainment system 700 supporting multiple connections and a method of the automotive infotainment system 700 supporting a device connection between multiple users.

An embodiment of the present disclosure easily supports a change in the connection of multiple user devices that have been registered with the automotive infotainment system 700 of a car. Accordingly, several users within cars may connect their devices to the automotive infotainment system 700, and can easily control audio and video in their cars by changing the devices, if necessary. In this case, there is an advantage in that the automotive infotainment system 700 can be used more flexibly and conveniently.

The method of supporting a device connection between multiple users that is targeted in an embodiment of the present disclosure is described as using Bluetooth or Wi-Fi, but the present disclosure is not essentially limited thereto. All of applicable wired and wireless communication methods may be applied to the method.

FIG. 7 is a block diagram of the automotive infotainment system 700 according to an embodiment of the present disclosure. The automotive infotainment system 700 according to an embodiment of the present disclosure may have the same construction as that illustrated in FIG. 4, and a detailed description thereof omitted.

The automotive infotainment system 700 according to an embodiment of the present disclosure includes a host container 710, a device connection management unit 720, a container management unit 730, and a media management unit 750.

The host container 710 is a core component of the automotive infotainment system 700, and is generated and started when the automotive infotainment system is booted. The host container 710 manages the device connection management unit 720, the container management unit 730, and the media management unit 750, and also manages a human machine interface (HMI) (hereinafter referred to as an “interface”) 760.

The device connection management unit 720 manages the multi-connection and disconnection of user devices that have already been registered with the automotive infotainment system 700. Furthermore, when at least one of user devices that have been connected to the automotive infotainment system 700 is disconnected or at least one of user devices that have been registered with the automotive infotainment system 700 is connected to the automotive infotainment system 700, the device connection management unit 720 may generate contents related to the connection or the disconnection as device connection information, and may transmit the contents to the container management unit 730.

The container management unit 730 is responsible for the generation, deletion, and control of a sub-container 740. As an embodiment, the container management unit 730 generates the sub-container 740 so that the sub-container 740 corresponds to the number of user devices connected to the automotive infotainment system. Specifically, the container management unit 730 may receive, from the device connection management unit 720, device connection information relating to a user device that has been connected to the automotive infotainment system, may receive user setting information by requesting the user setting information from the user device based on the device connection information, may generate the sub-container 740 so that the sub-container 740 corresponds to the number of user devices, and may generate setting information of the sub-container 740 based on the user setting information.

In this case, the sub-container setting information may include an application, content, and a UI configuration that will be provided through the sub-container 740. The user setting information may include access rights for each application and personal information.

The media management unit 750 manages data to be transmitted to and received from each sub-container 740 corresponding to a user device that has been connected to the automotive infotainment system. That is, the media management unit 750 allows data to be transmitted to each sub-container 740 to be stored and transmitted. Furthermore, the media management unit 750 may control media by transmitting, to the sub-container 740, media control information that has been transmitted through the interface 760.

In an embodiment of the present disclosure, if a user device is connected to the automotive infotainment system for the first time, the device connection management unit 720 transmits device connection information to the container management unit 730. The container management unit 730 receives user setting information by requesting the user setting information from the user device. The container management unit 730 generates the sub-container 740 based on the user setting information.

In contrast, in an embodiment of the present disclosure, if a user device that has already been registered with the automotive infotainment system is connected to the automotive infotainment system, the device connection management unit 720 searches, for already registered user devices, a predetermined range where the user devices can be connected to the automotive infotainment system according to communication methods around cars. Furthermore, when at least one user device is retrieved, the device connection management unit 720 transmits device connection information to the container management unit 730. The container management unit 730 receives user setting information by requesting the user setting information from the user device, and then generates the sub-container 740 based on the user setting information.

In this case, the container management unit 730 may generate the sub-container 740 so that the sub-container 740 corresponds to the number of user devices that have secured connectivity, among user devices currently being registered with the automotive infotainment system. For example, if first and second user devices are currently connected to the automotive infotainment system and a third user device now deviates from a connection support range (coverage) of the automotive infotainment system in the state in which the first to third user devices have been registered with the automotive infotainment system, the container management unit 730 may generate only two sub-containers 740 corresponding to the first and second user devices.

In this case, if the second user device deviates from a corresponding car and is no longer connected to the automotive infotainment system, the device connection management unit 720 may transmit changed device connection information to the container management unit 730. In response thereto, the container management unit 730 may delete a second sub-container corresponding to the second user device.

If a problem occurs when the sub-container 740 is generated, that is, if the sub-container 740 is not generated or the sub-container 740 is terminated during its operation, the container management unit 730 may perform a process of recovering the sub-container 740. As an embodiment, the container management unit 730 may determine whether a sub-container is present by mapping a user device that is now connected to the automotive infotainment system and the sub-container 740 that is now generated. Furthermore, if the sub-container 740 corresponding to a user device connected to the automotive infotainment system is not generated, the container management unit 730 may generate the corresponding sub-container 740 again.

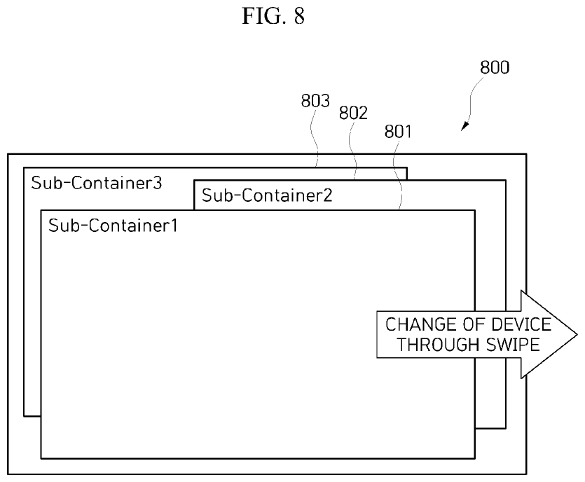

FIG. 8 is a diagram for describing contents in which a plurality of sub-containers is controlled in an embodiment of the present disclosure.

As an embodiment, the container management unit 730 may provide data to the sub-container 740 corresponding to at least any one user device selected by a user, among user devices that have been connected to the automotive infotainment system, and may provide a service corresponding to the data by displaying, on the interface 760, a sub-container screen 800 corresponding to the sub-container 740. In this case, the sub-container 740 is generated as many as the number of sub-containers 740 connected to the automotive infotainment system. The sub-container 740 that has been generated as described above may display, based on the sub-container screen 800, content (e.g., audio or media) corresponding to each user device.

In this case, a corresponding user may transmit, to the container management unit 730, a request to change the user device through the interface 760 of the automotive infotainment system. For example, if a user is currently connected to a first user device, but thereafter wants to change the first user device into a second user device, the user may transmit a corresponding request to the container management unit 730 through the interface 760.

In this case, the user may input a request to replace the sub-container 740 through a touch input or a swipe input to the sub-container screen 800 that is displayed on the interface 760 and that corresponds to a plurality of user devices connected to the automotive infotainment system. In this case, the touch or swipe input method is merely an example, and various input methods, for example, text input such as a number, may be applied to the present disclosure.

The container management unit 730 that has received the request for the change may replace a first sub-container 801 corresponding to the first user device while data are transmitted and received through the media management unit 750 with the second sub-container 802 corresponding to the second user device. At this time, the first sub-container 801 maintains a temporary waiting state without being deleted or terminated because the first user device is in the state in which the first user device has been connected to the automotive infotainment system.

As described above, the container management unit 730 can provide an environment in which a user can easily change his or her device into another device, by replacing the sub-container 740 that is now used when receiving a request to change the device from the user. Accordingly, there is an advantage in that several users can be provided with customized services through respective devices although the several users use the same automotive infotainment system.

Furthermore, in an embodiment of the present disclosure, a user can perform an input for media control through the interface 760. When receiving coordinate information corresponding to the input through the interface 760, the media management unit 750 may receive data for a command corresponding to the coordinate information by transmitting the command to the first user device, and may transmit the received data to the first sub-container 801 corresponding to the first user device.

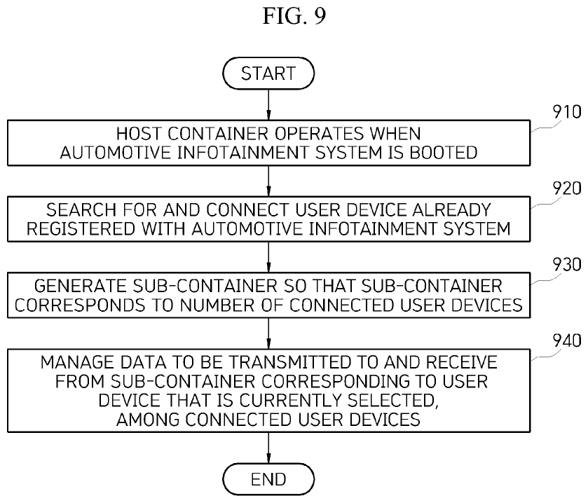

FIG. 9 is a flowchart of a method of supporting a device connection between multiple users in an embodiment of the present disclosure.

First, when the automotive infotainment system is booted, the host container operates (910).

Next, the device connection management unit searches whether a user device that has already been registered with the automotive infotainment system is present within a preset range, and connects the retrieved user device to the device connection management unit (920).

Next, the device connection management unit generates a sub-container so that the sub-container corresponds to the number of connected user devices (930).

Next, the media management unit manages data to be transmitted to and received from a sub-container corresponding to a user device that is now selected, among the connected user devices (940).

In the aforementioned description, steps 910 to 940 may be further divided into additional steps or may be combined into smaller steps depending on an implementation example of the present disclosure. Furthermore, some steps may be omitted, if necessary, and the sequence of steps may be changed. Furthermore, although contents are omitted, the contents described with reference to FIGS. 7 and 8 and the contents described with reference to FIG. 9 are mutually applied. Furthermore, the contents of the first embodiment, which have been described with reference to FIGS. 1 to 6, and the contents of the second embodiment, which have been described with reference to FIGS. 7 to 9, may also be mutually applied.

The method of providing a personalized infotainment virtualization service and the method of supporting a device connection between multiple users according to embodiments of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of providing an infotainment virtualization service, which is performed by a personalized infotainment virtualization system in a car sharing environment, the method comprising:
receiving personalized data from a cloud when receiving a request from a user;
storing the personalized data in a physical repository within an automotive infotainment system;
reading the personalized data by connecting a virtual repository that is generated through a virtual machine and the physical repository when the virtual machine is executed through a predetermined virtualization library; and
executing a service application that is to operate in the virtual machine based on the personalized data.

2. The method of claim 1, wherein the receiving of the personalized data from the cloud when receiving the request from the user comprises receiving any one of a request for car rental, a request for a car return, and a request to execute a specific service from any one of an unspecified number of users.

3. The method of claim 1, wherein the receiving of the personalized data from the cloud when receiving the request from the user comprises receiving user data comprising a car rental user ID, a rental car ID, and rental time information and service data comprising user driving information, device connection information, service use information, and other personal information.

4. The method of claim 3, further comprising:
receiving, from the cloud, the personalized data updated based on the user ID after the car is rented; and
updating the personalized data stored in the physical repository based on the updated personalized data.

5. The method of claim 3, wherein the executing of the service application that is to operate in the virtual machine based on the personalized data comprises:
detecting service use information included in the service data;
detecting user data corresponding to the service use information; and
executing a corresponding service application based on the service use information and the user data.

6. The method of claim 1, further comprising:
receiving a request for a car return from the user;
terminating the virtual machine that is being executed;
transmitting the personalized data stored in the physical repository to the cloud; and
discarding the personalized data stored in the physical repository.

7. The method of claim 6, wherein the transmitting of the personalized data stored in the physical repository to the cloud comprises transmitting, to the cloud, the personalized data of the physical repository in which personalized data that has been newly generated while the car is rented is also stored.

8. The method of claim 1, further comprising: after the executing of the service application that is to operate in the virtual machine based on the personalized data,
operating a host container when the automotive infotainment system is booted;
searching whether a user device that has already been registered with the automotive infotainment system is present within a preset range and connecting the retrieved user device to the automotive infotainment system; and
generating sub-containers so that the sub-containers corresponds to a number of connected user devices; and
managing data to be transmitted to and received from a sub-container corresponding to a user device that is now selected, among the connected user devices.

9. The method of claim 8, further comprising generating contents relating to a connection or a disconnection as the device connection information when at least one of the connected user devices is disconnected or at least one of the already registered user devices is connected.

10. The method of claim 8, wherein the generating of the sub-container so that the sub-container corresponds to the number of connected user devices comprises:
requesting user setting information from the connected user device based on device connection information of the connected user device; and
generating setting information of the sub-container based on the user setting information.

11. The method of claim 10, wherein the generating of the setting information of the sub-container based on the user setting information comprises generating the setting information of the sub-container comprising an application, content, and a UI configuration to be provided through the sub-container.

12. The method of claim 8, wherein the managing of the data to be transmitted to and received from the sub-container corresponding to the user device that is now selected, among the connected user devices, comprises:
providing the data to a sub-container corresponding to any one user device selected by the user, among the connected user devices; and
providing a service corresponding to the data by displaying a sub-container screen corresponding to the sub-container through an interface.

13. The method of claim 8, wherein the managing of the data to be transmitted to and received from the sub-container corresponding to the user device that is currently selected, among the connected user devices, comprises:
receiving, from the user, a request to change the user device through an interface of the automotive infotainment system; and
replacing a first sub-container corresponding to a first user device that is being used to transmit and receive the data with a second sub-container corresponding to a second user device.

14. The method of claim 13, wherein the managing of the data to be transmitted to and received from the sub-container corresponding to the user device that is currently selected, among the connected user devices, comprises replacing the first sub-container with the second sub-container when receiving, from the user, a touch input or swipe input to a sub-container screen corresponding to a plurality of the connected user devices that have been displayed on the interface.

15. The method of claim 8, wherein the managing of the data to be transmitted to and received from the sub-container corresponding to the user device that is currently selected, among the connected user devices, comprises:
receiving, from the user, coordinate information corresponding to a predetermined input through the interface;
receiving data corresponding to a command by transmitting, to a first user device, the command corresponding to the coordinate information; and
transmitting the data to a first sub-container corresponding to the first user device.

16. A personalized infotainment virtualization system in a car sharing environment, comprising:
a physical repository configured to store personalized data received from a cloud;
a kernel configured to manage the personalized data stored in the physical repository;
a virtual machine configured to generate a virtual repository when the virtual machine is executed through a predetermined virtualization library, read the personalized data by connecting the virtual repository to the physical repository, store the read personalized data in the virtual repository, and execute a service application that is to operate in a virtual environment based on the personalized data.
